(19) United States
(12) Patent Application Publication
(10) Pub. No.: US 2011/0285099 A1
(43) Pub. Date: Nov. 24, 2011

(54) Folding Serving Wagon

(76) Inventor: Aleksandr Volper, Forest Hills, NY (US)

(21) Appl. No.: 12/786,414

(22) Filed: May 24, 2010

(51) Int. Cl. B62B 3/02; B23P 17/04

(52) U.S. Cl. 280/47.11; 29/428

(57) ABSTRACT

A serving wagon having a main rectangular frame pivotally coupled to left and right front support members on one side of the frame and left and right rear support members on the other side of the frame. The support members are adapted to be positioned perpendicular to the rectangular frame or adjacent to and aligned with the side of the rectangular frame. The edges of top and bottom shelves having front and rear sections separated by a seam are pivotally coupled to the main frame to be in a closed position when in a vertical position, and connecting rods are pivotally coupled to the front and rear sections of the top and bottom shelves which transfer motion of one of the sections of a shelf to the same section of the other shelf.

### BACKGROUND OF THE INVENTION

1. Field of the Invention

The present invention relates generally to a serving wagon and more specifically to a wagon having casters which allows the wagon to be moved around a home while serving food or beverages located on shelves which can be folded to a vertical position for storage or can be folded to in half along their length to provide a wagon of reduced depth with shelves of reduced depth.

2. Description of Related Art

Serving wagons having shelves for moving items such as plates of food or beverages are known in the prior art. More specifically, by way of example, U.S. Pat. No. 6,561,599 to Itakura discloses a box-shaped body that is supported by casters and has an opened upper end. Two pullout wagon members are stowed in the body, which are pulled out toward the side directions during use. Upper surface plates of the pullout wagon members serve as a cover for covering the opening of the body and as a table. Tables mounted via hinges to the front and back sides of the body can be expanded horizontally to provide a large table surface.

U.S. Pat. No. 6,405,660 to Itakura, et al. discloses a first wagon including a lower face plate and an upper face plate constituting storage space, and a second wagon which is stored within the storage space of the first wagon. The longitudinal side edges of the upper face plate of said first wagon is equipped with auxiliary table plates rotatably connected thereto, and the first and second wagons are formed to rotate with the rotary axis set to a center column mounted to the center of the upper and lower face plates. The second wagon can be moved from a first position where the wagon is completely stored within the first wagon to a second position taking an angle of 90 degrees from the first wagon, and the auxiliary tables can each be pivoted from a position hanging from the upper face plate to a position leveled with the upper face plate.

U.S. Pat. No. 6,240,855 to Pirkl, et al. discloses a portable table assembly constructed of plastic and aluminum that may have a built-in shelving system, a light box for displaying backlit graphics, and lockable wheels for moving the closed table. The table has a hinged top, hinged doors, and may have hinged shelves, and collapses into a profile less than ten inches wide.

U.S. Pat. No. 6,053,116 to Jung, et al. discloses a foldable table having an upper support plate, first and second downward extending side support plates extending downward from the upper support plate, an upper pivot plate downward pivotable and hinged to the upper support plate, first and second side pivot plates inward pivotable and hinged to the first and second side support plates, and first and second wing plates formed at the first and second side pivot plates and upward pivotable therefrom.

U.S. Pat. No. 5,904,104 to Yu discloses a computer desk that can be collapsed and the height of its desk plate is adjustable.

U.S. Pat. No. 5,622,119 to Hsieh discloses a foldable computer table which can be folded to a minimum volume for easy storage and transport. The foldable computer table mainly includes a top board, a back board, two side wall panels, and two legs. The top board and the legs are pivotally connected to the side wall. Three different holding devices are separately provided on the side wall panels and the back board, to hold the folded top board and the folded and extended legs in place.

U.S. Pat. No. 5,303,057 to Davidow, et al. discloses a Cabinet structure for television sets of varying sizes having towers, adjustable means that span the area between the towers and includes a face plate, a shelf and a trim strip, each having relatively shiftable portions where the overall length may be regulated by shifting the portions so that they correspond essentially to the width of the television set.

U.S. Pat. No. 5,224,531 to Blohm discloses a portable apparatus for storing tools and converts to a combination saw table, router table and workbench. The apparatus can be readily maneuvered, loaded into a truck bed and stored when folded. It also provides a rigid work surface when in the set-up position.

### SUMMARY OF THE INVENTION

In an exemplary embodiment of the present invention, there is disclosed a serving wagon comprising:
a main rectangular frame having a top member, a bottom member and left and right side members;
left and right front support members pivotally coupled to the left and right side members of the rectangular frame and adapted to be positioned perpendicular to one side of the rectangular frame or adjacent to and aligned with the one side of the rectangular frame;
left and right rear support members pivotally coupled to the left and right side members of the rectangular frame and adapted to be positioned perpendicular to the other side of the rectangular frame or adjacent to and aligned with the other side of the rectangular frame;
a top shelf having a front section and a rear section separated by a seam wherein the edges of the front and rear sections at the seam are pivotally coupled to the main frame to be in a closed position when in a vertical position;
a bottom shelf having a front section and a rear section separated by a seam wherein the edges of the front and rear sections at the seam are pivotally coupled to the main frame to be in a closed position when in a vertical position; and
connecting rods pivotally coupled to the front and rear sections of the top and bottom shelves wherein motion of one of the sections of a shelf is transferred to the same section of the other shelf.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective front view of the folding serving wagon when fully opened in accordance with the principles of the invention;

FIG. 2 is a perspective front view of the folding serving wagon of FIG. 1 folded in half; and

FIG. 3 is a perspective rear view of the folding serving wagon of FIG. 1 folded in half.

### DESCRIPTION OF THE PREFERRED EMBODIMENT

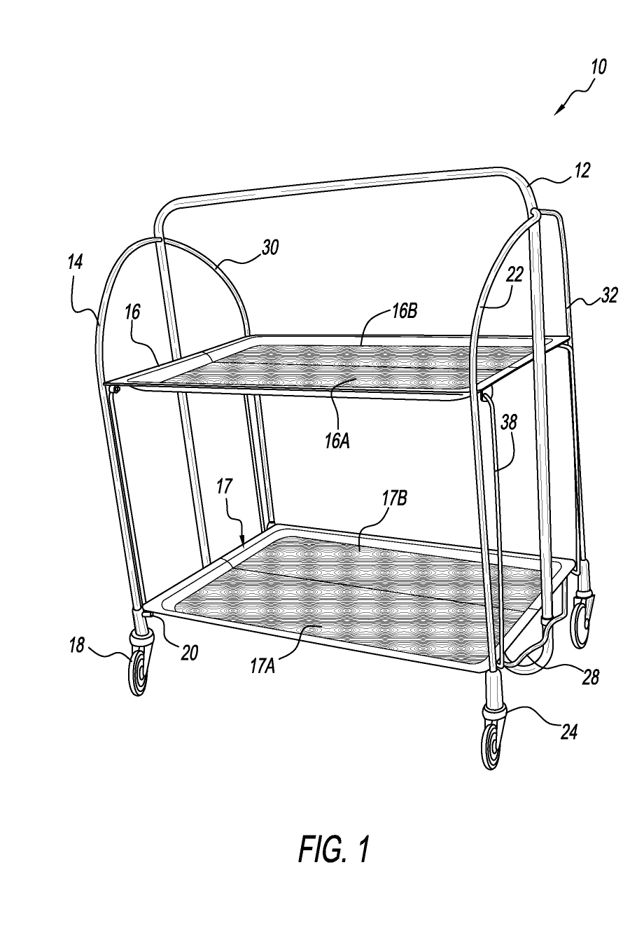

Referring to FIG. 1, there is disclosed a perspective front view of a folding serving wagon when fully opened. The folding serving wagon has substantially rectangular shelves where each shelf consists of a front section having a front end and a rear end, and a rear section having a front end and a rear end. When the folding serving wagon is fully open, the back edge of the front section of each shelf butts against the front edge of the rear section to form a single shelf having a flat, smooth, continuous shelf surface.

When the folding serving wagon is half closed, the rear section of each shelf is rotated up about its front edge to a vertical position and rear side frame members that were located at the sides of the shelves are rotated to be located behind the shelves to hold the rear sections of the shelves in their vertical position. At this time the rear section of each shelf is in a vertical position immediately behind the front section of the shelf and can prevent items on the shelf from being pushed off its rear edge. Additionally, by rotating the rear side frame members to be next to the backs of the vertical shelves, the depth of the folding serving wagon is reduced by about one half.

When the folding serving wagon is fully closed, the front and rear sections of the shelves are rotated up to their vertical positions, and front and rear side frame members are rotated toward the center of the vertical shelves to hold the shelves in their vertical position.

Thus, the folding serving wagon of the present invention can provide double the shelf area when required or compacted to reduce both the shelf area and the depth of the wagon by about one half when the need arises. Additionally, when not in use, the serving wagon can be compacted to a narrow structure where the shelves are positioned in their space saving vertical position and the serving wagon can be rolled, not carried or lifted to a convenient area for storage. To use the serving wagon for the first time after it has been stored away, it is rolled from its storage area to a place where various items such as dishes platters of food, etc can be placed on the shelves.

Referring to FIG. 1, there is shown a perspective front view of the folding serving wagon 10 when fully opened in accordance with the principles of the invention. The collapsible folding serving wagon comprises a substantially rectangular main frame member 12 made of chrome plated steel or anodized aluminum tubing having a diameter of between one inch and two inches where a diameter of one or one and one-quarter of an inch is preferred. Each corner of the substantially rectangular frame is bent to form a ninety degree angle with a generous radius.

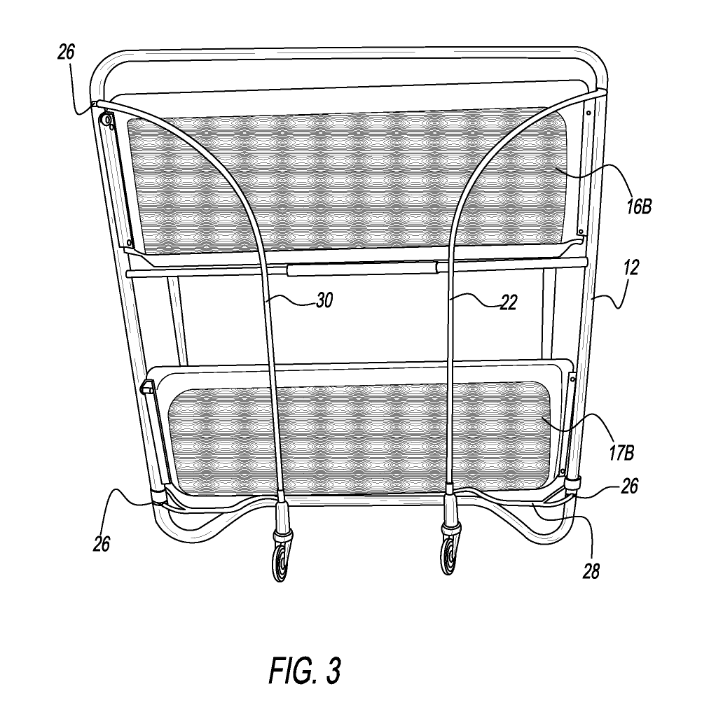

Pivotally connected to the main frame member 12 is a left front support member 14 which can be made of one-half or five eighths of an inch diameter steel or aluminum tubing. The top section of the left front support member has a generous radius which is substantially equal to the depth of a shelf which projects out from the main frame member 12 and extends straight down to a swivel caster 18 which has a wheel of about two inches, more or less, in diameter. The top end of the left front support member is bent to provide a vertical end with a length of about three-quarters of an inch (not shown) which is located in a substantially horizontal opening 26, see FIG. 3, in the main frame member. The vertical end prevents the support member from being removed from the main frame member and the horizontal opening allows the left front support member to rotate ninety degrees from a position that is perpendicular to the main frame member to a position that is parallel to the main frame. A cross member 20 is rigidly attached to the bottom end of the left front support member and rotatably connected to the main frame member 12 with a bent end located in a substantially horizontal opening in the main frame member as the top end of the support member is rotatably connected to the main frame member. Thus, the left front support member can rotate from a position that is perpendicular to the frame member to a position that is aligned with and is adjacent to the frame member.

Pivotally connected to the opposite side of the frame member 12 is a right front support member 22 which can be made of one-half or five eighths of an inch diameter steel or aluminum tubing. The top section of the right front support member has a generous radius which is substantially equal to the depth of a shelf which projects out from the main frame member 12 and the support member extends straight down to a swivel caster 24 which has a wheel of about two inches, more or less, in diameter. The top end of the right front support member is bent to provide a vertical end with a length of about three-quarters of an inch which is located in a substantially horizontal opening 26, see FIG. 3, in the main frame member. The vertical end prevents the support member from being removed from the main frame member and the horizontal opening 26 allows the left front support member to rotate ninety degrees from a position that is perpendicular to the main frame member to a position that is adjacent to and parallel to the main frame. One end of a cross member 28 is rigidly attached to the bottom end of the right front support member 22 and the other end is rotatably connected to the main frame member 12 with a bent end located in a substantially horizontal opening in the main frame member as the top end of the support member is rotatably connected to the main frame member. Thus, the right front support member can rotate from a position that is perpendicular to the frame member to a position that is aligned with and is adjacent to the frame member but cannot move vertically up or down relative to the main frame.

The swivel casters 18, 24 that are located at the bottom of the left and right front support members are lower than the bottom of the main frame member and, therefore, raise the bottom of the main frame off the floor.

Pivotally connected to the left rear side of the main frame member 12 is a left rear side support member 30, and pivotally connected to the right side of the main frame member 12 is a right rear side support member 32. The pivotal connections of the left and right rear side support members with the main frame support member 14 are similar to the connections of the left and right front side support members with the main frame member and, therefore, will not here repeated.

Continuing with FIG. 1, the folding serving wagon has two shelves, a top shelf 16 and a bottom shelf 17. Each shelf consists of two sections where the top shelf has a front section 16A and a rear section 16B. In a similar manner the bottom shelf 17 consists of a front section 17A and a rear section !7B. The rear edge of the front section 16A of the top shelf 16 is pivotally connected to the main frame member and the front edge of the shelf can rotate about an angle of ninety degrees from a horizontal position to a vertical position. In a similar manner the rear edge of the front section 17A of the bottom shelf 17 is pivotally connected to the main frame member and the front edge of the shelf can rotate about an angle of ninety degrees from a horizontal position to a vertical position.

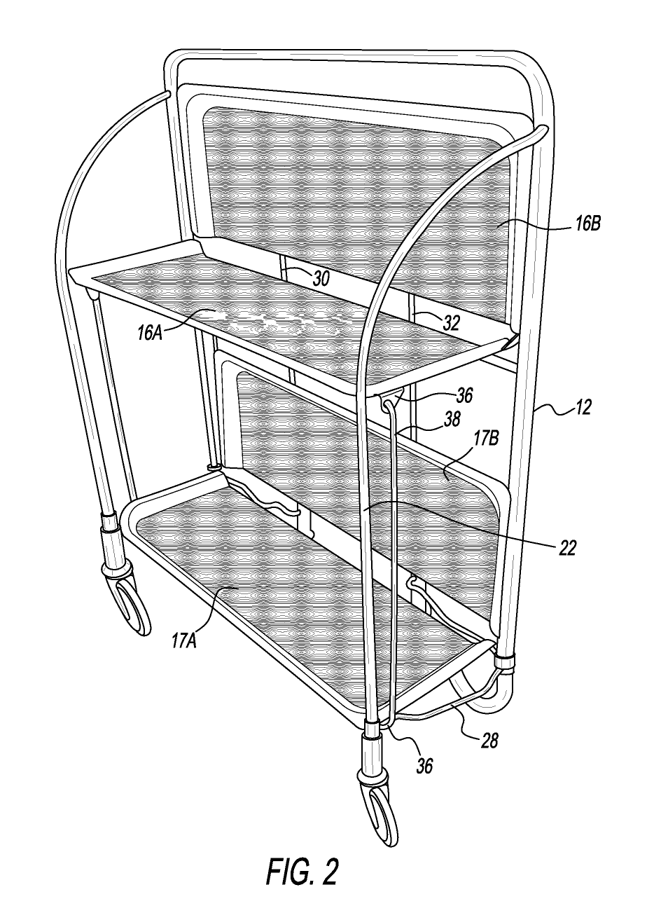

Pivotally attached to the left and right front bottom edges of the front sections of the top and bottom shelves 16A and 17A are brackets 36, see FIG. 2, which are pivotally connected to a connecting rod 38 which can be of steel or aluminum with a diameter of about one-half of an inch. A stop member (not shown) which can be a part of the connection rod 38 rests on top of the left and right cross members to keep the front sections 16A, 17A of the top and bottom shelves in their horizontal position and, when the front section of the top shelf is rotated from a horizontal open position to a vertical closed position, the front section of the bottom shelf will automatically follow.

The rear attachments of the sections 16B and 17B of the top and bottom shelves to the main frame member, to each other and to connecting rods are similar to the attachments of sections 16A and 17A of the top and bottom shelves is every way and, therefore, will not again be repeated.

Referring to FIG. 2, there is shown a perspective front view of the folding serving wagon of FIG. 1 folded in half. In this view the front edges of the rear sections 17B and 16B of the top and bottom shelves 17, 16, are rotated up to position the shelves to their closed vertical positions, and the left 30 and right 32 rear side support members have been rotated to be adjacent to the bottoms of the vertical shelve sections. When the folding serving wagon is half closed as shown in FIG. 2, the rear sections of the top and bottom shelves become backs for the front sections of the shelves to prevent items from being pushed off the back of the front sections of the shelves. In addition, the folding serving wagon is fully supported by the four swivel castor wheels and, therefore, can be safely and easily rolled to a desired location.

Referring to FIG. 3, there is shown a perspective rear view of the folding serving wagon of FIG. 1 folded in half. In this view it can be seen how the left and right rear side support members prevent the rear sections of the top and bottom shelves from falling down to their open position.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A serving wagon comprising:
a main rectangular frame having a top member, a bottom member and left and right side members;
left and right front support members pivotally coupled to the left and right side members of the rectangular frame and adapted to be positioned perpendicular to one side of the rectangular frame or adjacent to and aligned with the one side of the rectangular frame;
left and right rear support members pivotally coupled to the left and right side members of the rectangular frame and adapted to be positioned perpendicular to the other side of the rectangular frame or adjacent to and aligned with the other side of the rectangular frame;
a top shelf having a front section and a rear section separated by a seam wherein the edges of the front and rear sections at the seam are pivotally coupled to the main frame to be in a closed position when in a vertical position;
a bottom shelf having a front section and a rear section separated by a seam wherein the edges of the front and rear sections at the seam are pivotally coupled to the main frame to be in a closed position when in a vertical position; and
connecting rods pivotally coupled to the front and rear sections of the top and bottom shelves wherein motion of one of the sections of a shelf is transferred to the same section of the other shelf.

2. The serving wagon of claim 1 wherein the edges of the front and rear sections at the seam are pivotally coupled to the main frame along an axis that is located above the plane of the shelf when in its horizontal position.

3. The serving wagon of claim 2 wherein swivel casters are located on the left and right front support members and the left and right rear support members.

4. The serving wagon of claim 3 wherein the connecting rods engage cross members located between the support members and the main rectangular frame to provide support for the first and second shelves.

5. The serving wagon of claim 4 wherein the pivotal coupling between the support members and the rectangular frame includes a rectangular opening in the rectangular frame that allows the support members to rotate only about the longitudinal axis of the side members of the rectangular frame.

6. The serving wagon of claim 5 wherein the rear section of each shelf is a rear wall for the front section of each shelf when the rear section of each shelf is in a closed position.

7. The serving wagon of claim 6 wherein the various components other than the shelves are made of steel or aluminum.

8. A method of making a serving wagon comprises:
providing a main rectangular frame having a top member, a bottom member and left and right side members;
providing left and right front support members pivotally coupled to the left and right side members of the rectangular frame and adapted to be positioned perpendicular to one side of the rectangular frame or adjacent to and aligned with the one side of the rectangular frame;
providing left and right rear support members pivotally coupled to the left and right side members of the rectangular frame and adapted to be positioned perpendicular to the other side of the rectangular frame or adjacent to and aligned with the other side of the rectangular frame;
providing a top shelf having a front section and a rear section separated by a seam wherein the edges of the front and rear sections at the seam are pivotally coupled to the main frame to be in a closed position when in a vertical position;
providing a bottom shelf having a front section and a rear section separated by a seam wherein the edges of the front and rear sections at the seam are pivotally coupled to the main frame to be in a closed position when in a vertical position; and
pivotally coupling connecting rods to the front and rear sections of the top and bottom shelves wherein motion of one of the sections of a shelf is transferred to the same section of the other shelf.

9. The method of claim 8 wherein the edges of the front and rear sections at the seam are pivotally coupled to the main frame along an axis that is located above the plane of the shelf when in its horizontal position.

10. The method of claim 9 wherein swivel casters are located on the left and right front support members and the left and right rear support members.

11. The method of claim 10 wherein the connecting rods engage cross members located between the support members and the main rectangular frame to provide support for the first and second shelves.

12. The method of claim 11 wherein the pivotal coupling between the support members and the rectangular frame includes a rectangular opening in the rectangular frame that allows the support members to rotate only about the longitudinal axis of the side members of the rectangular frame.

13. The method of claim 12 wherein the rear section of each shelf is a rear wall for the front section of each shelf when the rear section of each shelf is in a closed position.

14. The method of claim 13 wherein the various components other than the shelves are made of steel or aluminum.
